(19) United States
(12) Patent Application Publication
(10) Pub. No.: US 2021/0378463 A1
(43) Pub. Date: Dec. 9, 2021

(54) LADDERMAN'S BUDDY - A PORTABLE URINAL FOR OUTDOORS

(71) Applicants: Michael P. Miller, South Lyon, MI (US); Wayne D. Daniel, Gregory, MI (US)

(72) Inventors: Michael P. Miller, South Lyon, MI (US); Wayne D. Daniel, Gregory, MI (US)

(21) Appl. No.: 16/896,499

(22) Filed: Jun. 9, 2020

(51) Int. Cl. A47K 11/12

(52) U.S. Cl. CPC A47K 11/12

(57) ABSTRACT

A system and method for providing a complete urinal system for outdoor enthusiasts who utilize an elevated platform or stand for extended periods of time is disclosed. The urinal system includes a urinal unit assembly, a flexible hose, and a urine collection assembly, which contains odor-controlling media. The urinal unit assembly is detachably connected at elevation directly to the hunting stand, tree, or branch, while the urine collection assembly is placed below the platform or stand, typically on the ground. The flexible hose connects the two assemblies.

### TECHNICAL FIELD

This application relates in general to a system for providing a hunting and outdoor aid and more specifically, to a system for providing a portable urinal for use outdoors.

### BACKGROUND

Hunters in elevated stands for extended time often require bladder relief Lost shot opportunities result when wild animals are scared off by excessive noise, odor, and movement. Elevated hunters generally urinate in one of the following ways: a) the hunter climbs down from the elevated position and urinates on the ground in the vicinity of the stand/tree, b) the hunter climbs down from the elevated position and urinates into a grounded bottle, jug, bucket, or similar type of vessel, c) the hunter freely urinates from the elevated position to the ground, and d) the hunter urinates from the elevated position into a bottle, jug, bucket or similar type of vessel. In each of these instances, shot opportunities are lost.

Shot opportunities are lost when the hunter climbs down from the elevated position and urinates on the ground in the vicinity of the stand/tree because uncontained urine causes odor and noise when splashing dry leaves/frozen ground/puddled snow/etc., because uncontained urine odor remains detectable for long periods of time, because descension/ascension presents excessive movement, because descension/ascension causes the stand/ladder/hardware to shake and make unnatural noise, and because descension/ascension to and from an elevated position increases the risk of falling and injury.

Shot opportunities are lost when the hunter climbs down from the elevated position and urinates into a grounded bottle, jug, bucket, or similar type of vessel, because ascension/descension presents excessive movement, because ascension/descension causes the stand/ladder/hardware to shake and make unnatural noise, because ascending and descending to and from an elevated position increases the risk of falls and injury, because bottles and similar vessels with limited capacity require frequent emptying on the ground causing uncontained odor, because bottles and similar vessels are often forgotten by the hunter, thereby forcing uncontained urination resulting in excessive noise and odor, because bottles and similar vessels have small openings leading to errant urine aim/spillage resulting in unhealthy, poor, uncontained hygiene odor, and uncontained urine odor remains detectable for long periods of time, repelling prey.

Shot opportunities are lost when the hunter freely urinates from elevated position to the ground, because uncontained urine causes odor and noise when splashing on dry leaves/frozen ground/etc., because uncontained urine causes odor and noise when hitting branches/foliage/ladder/etc. between the elevated stand and the ground, and uncontained urine odor remains detectable for long periods of time, causing animals to avoid the area.

Shot opportunities are lost when the hunter urinates from an elevated position into a bottle or similar vessel with limited capacity, because emptying urine onto the ground causes uncontained odor, because bottles and similar vessels are often forgotten forcing uncontained urination resulting in excessive noise and odor, because bottles and similar vessels require frequent ascension/descension from ground to stand, thereby presenting risk of drops that cause alarming noise, leakage, and odor, because bottles and similar vessels at elevation require storage presenting risk of drops that may result in alarming noise, leakage, and odor, because bottles and similar vessels have small openings leading to errant urine aim/spillage that results in poor, unhealthy hygiene uncontained odor, and uncontained urine odor remains detectable for long periods of time, repelling nearby animals. Therefore, a need exists for a portable urinal for use by hunters and sportsmen when they are using a raised platform or stand.

### SUMMARY

In accordance with the present invention, the above and other problems are solved by providing a system for a portable urinal for use in elevated outdoor stands and platforms according to the principles and example embodiments disclosed herein.

In one embodiment, the present invention is a system for providing a portable urinal for use in elevated outdoor stands and platforms, the system includes a urinal unit assembly, a flexible hose connecting the exit port of the urinal body to the threaded barbed hose connector on a lower resealable lid assembly within a urine collection assembly, the urine collection assembly, and odor controlling media within a urine container. The urinal unit assembly includes a urinal body having an inflow opening for accepting urine from a user and an exit port coupled to a flexible hose for connecting to the urine collection assembly, a lanyard assembly for coupling the urinal body at two elevated locations, a tether assembly for coupling an upper resealable lid to the urinal body, and an upper resealable lid for coupling to the urinal body which completely covers the inflow opening of the urinal body providing an air-tight seal. The urine collection assembly includes a lower resealable lid assembly having the threaded barbed hose connector and a barbed hose connector nut coupled to the threaded barbed hose connector holding the threaded barbed hose connector to the lower resealable lid assembly, and a urine container coupled to the lower resealable lid assembly providing an air tight seal.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system for providing a portable urinal for use in elevated outdoor stands and platforms according to the present invention.

FIG. 2a-f illustrate an example embodiment of a funnel and lid used in a system for providing a portable urinal for use outdoors in elevated stands and platforms according to the present invention.

FIG. 3 illustrates an example embodiment of a collection bucket in a system for providing a portable urinal for use outdoors in elevated stands and platforms according to the present invention.

FIG. 4a-b illustrate a lid for a collection bucket for use in a system for providing a portable urinal for use in outdoor elevated stands and platforms according to the present invention.

### DETAILED DESCRIPTION

This application relates in general a system for providing an outdoor hunting and camping aid, and more specifically, to a system for providing a portable urinal for use outdoors in elevated stands and platforms according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers” should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specifications and claims are approximations that may vary depending upon the desired properties sought to be obtained by the present disclosure. At the very least, and not as an attempt to limit the application of the doctrine of equivalents to the scope of the claims, each numerical parameter should be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The terms “hunter,” “camper,” and “user” refer to an entity, e.g. a human, using the portable urinal for outdoors associated with the invention. The term “user” herein refers to one or more users.

The term “invention” or “present invention” refers to the invention being applied for via the patent application with the title “Ladderman's Buddy: A Portable Urinal for Outdoors.” Invention may be used interchangeably with “portable urinal.”

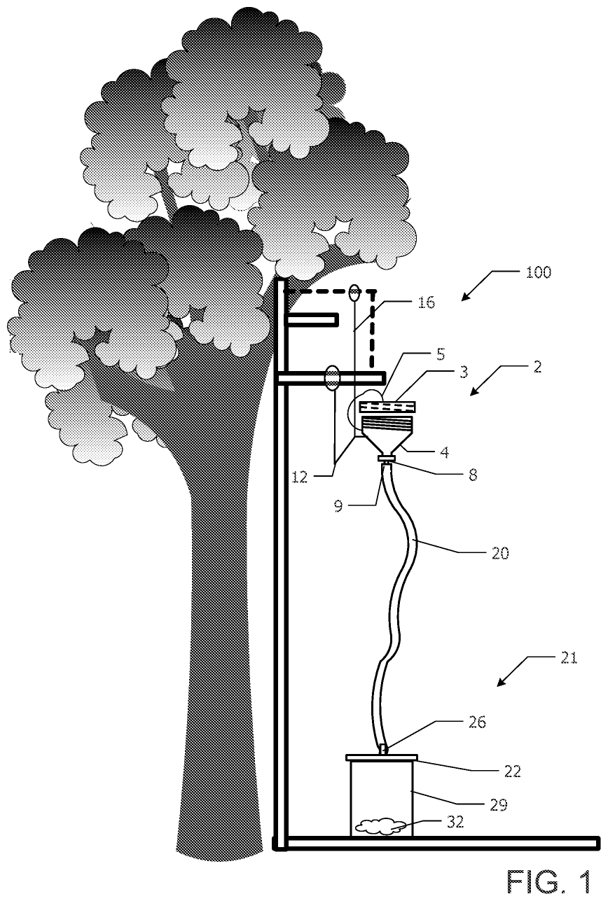

In general, the present disclosure relates to a system for providing a portable urinal for use outdoors. To better understand the present invention, FIG. 1 illustrates an example embodiment for a system 100 for providing a portable urinal for use outdoors according to the present invention. The Ladderman's Buddy 100 primarily consists of a urinal unit assembly 2, a flexible hose 20, and a urine collection assembly 21, which contains odor controlling media 32 (not shown). The urinal unit assembly 2 is detachably connected in two separate spots at elevation directly to the hunting stand or platform, branch, limb, or tree.

The urine collection assembly 21 is at a position well below the urinal unit assembly 2, preferably on the ground. The flexible hose 20 is detachably connected to and between both the urinal unit assembly 2 and the urine collection assembly 21 as detailed below. The odor controlling media (not shown) is placed on the interior floor of the urine collection assembly 21.

In general, the hunter urinates into the urinal unit assembly 2, the urine flows down through the flexible hose 20, and is deposited into the sizable urine collection assembly 21 where both the urine and accompanying odor are contained and neutralized via a mixture with an odor-controlling media 32 (not shown).

While on the elevated stand, the hunter urinates through an inflow opening 7 into the non-metallic urinal body 4 of the urinal unit assembly 2. The inflow opening 7 has a diameter which may range from 2 to 6 inches, thereby helping to guard against errant aim/spillage. Said diameter is not so large as to make the urinal unit assembly 2 excessively bulky and less maneuverable.

The urine is marshalled as it flows unimpeded downward and exits from the combined feature of an exit port of the urinal body 8 and a barbed hose connector 9. If manufacturable with a favorable cost analysis, the “barbed” feature may be molded directly into the urinal body 4 thereby eliminating the need for a separate barbed hose connector 9. The non-metallic nature of the urinal body 4 allows for relatively quiet urine inflow and marshalling and is also unaffected by corrosive factors prevalent in urine.

The urine then flows through the flexible hose 20 and is pulled down by gravity to the urine collection assembly 21 positioned well below the elevated stand. Having a maneuverable urinal unit assembly 2 within reach while at elevation renders the need for hunter ascent/descent unnecessary.

When transferring the Ladderman's Buddy to/from the hunting stand, portability is optimized due to the self-contained nature of the system. The urinal unit assembly 2, a detached flexible hose 20, and a limited amount of odor controlling media 32 concurrently fit entirely within the urine collection assembly 21 with its lower resealable lid assembly 22 in place. This portable package is carried by an integrated handle of the urine container 31. It's up to the hunter to decide what brand and how much of the odor controlling media 32 to bring separately if desired.

The Ladderman's Buddy 100 may be taken to the hunting stand well before the season starts and usefully left there throughout the season or longer since the urine collection assembly 21 has a recommended volume of 5 gallons. It's up to the hunter to determine if and when maintenance is required. To maintain this system 100, the lower resealable lid assembly 22 is detached from the open end of the urine container 30, followed by stirring-in the odor controlling media 32. Re-attachment of the lower resealable lid assembly (Item 22) completes the process. This process works until all the odor controlling media 32 has been saturated. Once saturated, the hunter simply adds fresh amounts of the odor controlling media 32 and repeats this process until the urine collection assembly becomes full or unmanageable. Depending on the hunter's selection of a particular odor-controlling media 32 and choice of how to discard it, the used odor controlling media 32 may be emptied to the ground or removed from the area since the urine is “clumped” and its odor is neutralized.

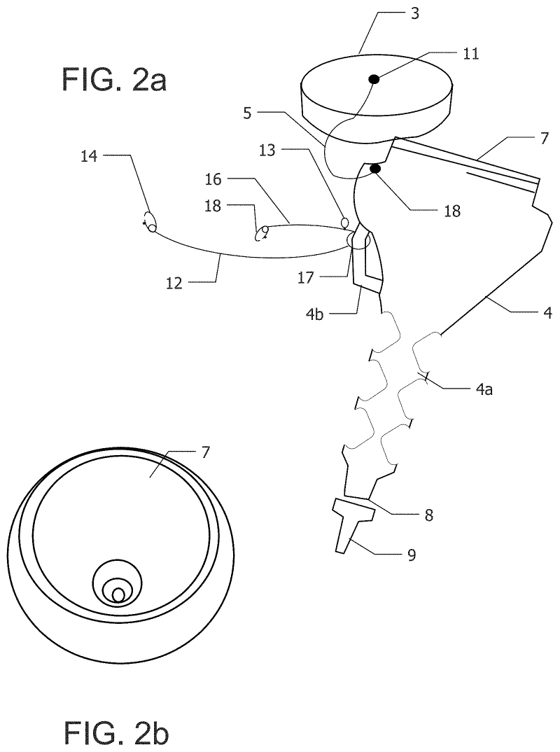

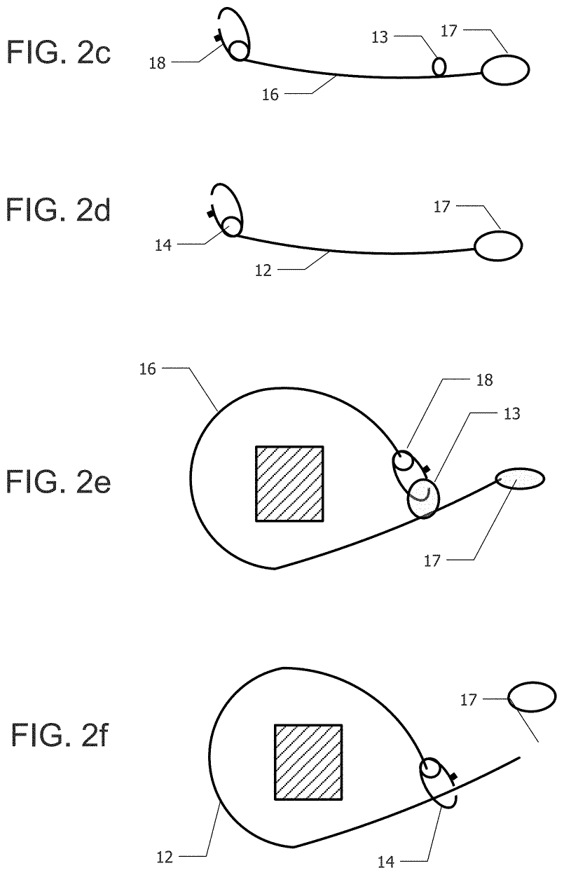

The urinal unit assembly 2 is detachably connected in two differing spots at elevation to the hunting stand/tree/structure. As such, the urinal unit assembly is a resealable handheld manuverable unit. Both of these detachable connections are realized via integrated attachment clips 14 and 18 (snap-clip, carabiner, other) at each of the two ends of soft and flexible main lanyard assembly 15, which in turn is permanently attached to urinal body 4 utilizing a knot 17 tied directly to integrated handle 4b as presented in FIG. 2a. In another embodiment, the permanent attachment of lanyard assembly 15 to urinal body 4 could be achieved via Velcro™, adhesive, Chicago rivet, eyelet, or other standard approaches.

The above mentioned attachment clips are each integrated to said lanyard via tie knot or end connection hardware such as swage sleeve, ferrule, or any other common practice for attaching like devices—not shown. After permanent attachment of lanyard assembly 15 to urinal body 4, one could describe main lanyard assembly 15 as having two ‘arms’: one short and the other long. FIG. 2c presents the ‘short arm’ of main lanyard assembly 15 as having soft/flexible segment 16, integrated loop 13, and attachment clip 18 all branching out from loop knot 17. FIG. 2d presents the ‘long arm’ of main lanyard 15 as having soft/flexible segment 12 and attachment clip 14, both of which are shown branching out from loop knot 17. The soft/flexible nature of segments 12 and 16 ensures relatively quiet interface with anything they contact or wrap around while urinal unit assembly 2 is in ‘stored’ configuration. In a separate embodiment (not shown), the ‘short arm’ might be replaced by a large attachment clip (carabiner, other) directly integrated to urinal body 4 without presenting a soft/flexible segment 16. In yet another embodiment (not shown) each of the arms, long and short, may be separate/non continuous assemblies thereby eliminating a single main lanyard assembly 15 from which both arms are provided.

To store the Ladderman's Buddy at elevation both the ‘long arm’ and ‘short arm’ are attached to the stand/tree/structure utilizing attachment clips 14 and 18.

The soft flexible segment 16 of the ‘short arm’ is wrapped around the elevated branch/tree/structure (such as an armrest) which is in near proximity to the hunter thereby minimizing movement when the urinal unit assembly is deployed for use. Attachment clip 18 snaps onto the soft/flexible segment 16 or snaps onto integrated loop 13 (hunter's choice) as shown in FIG. 2e. Attachment clip 18 is detached/reattached each time the urinal is used.

The soft flexible segment 12 of the ‘long arm’ is wrapped around the elevated branch/tree/structure (such as a footrest) in a location that permits maneuverability of the urinal unit assembly 2 when deployed for use and is present to prevent the said urinal assembly from falling to the ground if accidentally dropped. Attachment clip 14 snaps onto soft/flexible segment 12 as shown in FIG. 2f. Attachment clip 14 is detached only when the hunter wants to take the “Ladderman's Buddy” down. To utilize Ladderman's Buddy, the hunter detaches the urinal unit assembly 2 from the hunting stand/branch/tree/structure by “unhooking” attachment clip 18 from loop 13 or soft flexible segment 16 depending on how clip 18 is attached as chosen by the hunter. This approach allows for easy and quiet deployment with minimal movement and no risk of alarming noises caused by impact of urinal unit assembly 2 with the ground.

Once detached, the upper resealable lid 3 is disconnected from the inflow opening of the urinal body 7 thereby rendering the urinal unit assembly 2 ready for use. The connection between the upper resealable lid 3 and the inflow opening of the urinal body 7 may be either “screw-on” (like ajar) or “snap-on” (like a plastic lid on a coffee can), thereby ensuring the urinal unit assembly 2 is well sealed after use.

FIG. 2a-b illustrate an example embodiment of a funnel and lid used in a system for providing a portable urinal for use outdoors according to the present invention. Ladderman's Buddy is a complete urinal system for outdoor enthusiasts who utilize an elevated platform or stand for extended periods of time. The Ladderman's Buddy comprises a urinal unit assembly, a flexible hose 20, a urine collection assembly 21, and an odor controlling media 32 (such as cat litter).

The urinal unit assembly 2 is air-tight resealable, manuverable, and acts as a urine marshalling vessel. The urinal unit assembly 2 consists, in part, of an upper resealable lid 3, inflow opening 7, a urinal body 4 having an integrated flex zone 4a and integrated handle 4b, an exit port 8, and a barbed hose connector 9. Additionally, urinal unit assembly 2 includes tether 5 which connects at one end to upper resealable lid 3 and the other end to urinal body 4. Also included as part of urinal assembly 2 is lanyard assembly 15 as shown in FIGS. 2a thru 2f, or alternatively derivatives/substitutions of lanyard assembly 15 as summarized but not shown in 0028 and 0029 above. Lanyard assembly 15 or it's substitutions are made from coated cable, paracord, etc. all of which are resistant to extreme weather conditions/UV exposure. As such, segments 12 and 16 are soft/flexible by default. In this embodiment the free end of the ‘short arm’ and free end of the ‘long arm’ of lanyard assembly 15 are each equipped with a clasp/snap clip/carabiner or other similar device, both of which are secured to each arm via conventional means/hardware such as crimp sleeves, ferrules, tied knots, etc. As noted above, these devices are wrapped around the tree/stand/structure and connected back onto their respective flexible segments 12 and 16. Alternatively, the hunter may choose to attach said clasp at terminus of segment 16 onto the integrated loop 13 as shown in FIG. 2a thru FIGS. 2c. Also within this embodiment lanyard assembly 15 is tied to urinal body 4 at integrated handle 4b as shown in FIG. 2a.

The upper resealable lid 3 is used to seal off the urinal body 4 via detachable sealed connection (screw-on or snap-on) to an inflow opening of the urinal body 7. The urinal body includes an integrated flex zone 4a, an integrated handle 4b, an inflow opening 7, and an exit port 8, and barbed hose connector 9.

The integrated flex zone 4a is an accordion-style device. The integrated handle 4b is a “molded-in” handle. The inflow opening 7 is located at the mouth of the unit. The user urinates into this opening. The upper resealable lid 3 either screws on or snaps on (i.e., resealable bucket lid style) the opening to provide a sealed, closed vessel once urination is complete. The exit port 8 allows urine to flow unimpeded through this opening into the barbed hose connector 9, then into the flexible hose 20.

The barbed hose connector 9 is affixed to the exit port 8 either via threading or adhesive or both methods. The exit port 8 may include an integrated hose barb in alternate embodiments to replace a separate barbed hose connector 9. In this case, the urinal body 4 has the barbed feature for hose attachment molded-in. Urine flows through this opening directly into the flexible hose 20.

Tether 5 connects at one end 18 to urinal body 4 and at the other end 11 to upper resealable lid 3 to the urinal unit assembly 2. Tether 5 may be a paracord string, coated cable, polymer strip, etc. all of which are flexible and resistant to extreme weather conditions/UV exposure, etc. In this embodiment tether 5 is paracord tied directly to urinal body 4 using a knot, however eyelet and rivet, screw, adhesive, Velcro™ or any other standard attachment method may be used. Additionally, tether 5 is attached to upper resealable lid 3 utilizing a “Chicago Screw” and spacer. Again, any other standard attachment means is permissible. Urinal unit assembly 2 is attached to tree/stand/structure in two separate locations using both the short arm and the long arm of lanyard assembly 15.

Segment 12 is the cord body of the ‘long arm’ which is flexible cable, paracord, string, or other material which is resistant to degradation caused by foul weather conditions/UV sunlight/etc. Segment 12 must provide a relatively quiet interface with adjoining parts. Attachment clip 14 is integrated to the ‘free’ terminus end of segment 12 via standard integration methods/hardware including but not limited to: direct tie knot, crimp sleeve, ferrule, etc. This embodiment presents segment 12 and the above mentioned integrated components as one ‘long arm’ of main lanyard assembly 15.

Segment 16 is the cord body of the ‘short arm’ which is flexible cable, paracord, string, or other material which is resistant to degradation caused by foul weather conditions/UV sunlight/etc. Segment 16 must provide a relatively quiet interface with adjoining parts. Attachment clip 18 is integrated to the ‘free’ terminus end of segment 16 via standard integration methods/hardware including but not limited to: direct tie knot, crimp sleeve, ferrule, etc. Segment 16 also presents integrated loop 13 as shown in FIGS. 2a, 2c, and 2e. This embodiment presents segment 16 and the above mentioned integrated components as one ‘short arm’ of main lanyard assembly 15.

Main lanyard assembly 15 is partially comprised of a long section of cord having soft/flexible properties. The cord may be flexible cable, paracord, string, or other material which is resistant to degradation caused by foul weather conditions/UV sunlight/etc. The end sections of lanyard assembly 15 are defined as being a ‘long arm’ and a ‘short arm’. The cord section between these arms is attached to the urinal body via a tied knot 17 at handle 4b as shown in FIG. 2a. Instead of using a tied knot 17, an alternative embodiment might use standard attachment hardware/methods such as screw, rivet, adhesive, Velcro™ etc. In another embodiment, the ‘short arm’ and ‘long arm’ may be two separate lanyard assemblies instead of being connected as is the case with lanyard assembly 15. The means by which these separate individual lanyard assemblies are attached to urinal body 4 could be through but not limited to tie knots, screw, rivet, adhesive, Velcro™ etc.

The flexible hose 20 has an upper end that connects to a barbed hose connector 9 at the exit port 8 of urinal body 4. The flexible hose 20 also has a lower end that connects to a threaded barbed hose connector 26 which is part of the lower resealable lid assembly 22 used to detachably seal-off the urine container 29 from the urine collection assembly 21.

The upper resealable lid 3 and urinal body 4 are non-metallic thereby adding to the relative quietness with minimal movement and is also unaffected by corrosive factors in urine. The sealed nature of this connection guards against spillage and the resultant odor emission into the wind/air at elevation. The upper resealable lid 3 is also connected to the urinal body 4 with tether 5.

The soft nature of tether 5 provides a relatively quiet interface with anything it touches. This approach eliminates the possibility of dropping a loose upper resealable lid 3 to the ground so that a hunter doesn't make noise retrieving an errant lid.

For comfortable use, the hunter needs the urinal unit assembly 2 to be easily maneuverable and controllable. To achieve this, the urinal unit assembly 2 has an integrated flex zone 4b as well as an integrated handle 4a. These features help ensure the hunter isn't forced to assume a specific position/orientation as with an otherwise rigid system. The urinal unit assembly 2 and the attached upper end of the flexible hose 20 may be brought to the hunter instead of vice-versa. There's no constraining rigidity of a “hard plumbed” system. This approach minimizes movement, resultant noise, discomfort, errant aim, poor hygiene/sanitation, odor, and possible instability at elevation.

The upper end of the flexible hose 20 is pressed onto/over the barbed feature provided by the barbed hose connector 9 as present in this embodiment. This pressed connection may be carefully detached without damage to hose or barb, as needed for maintenance, portability, and hose replacement. This connection is leak-proof and doesn't require tools as with the use of mechanical clamps, hose rings, etc. The barbed features and the flexible hose 20 are non-metallic, thus unaffected by the corrosive factors in urine and also ensuring quietness as urine passes from the urinal unit assembly 2 downward through the flexible hose 20. The flexible hose 20 inside diameter may range anywhere from 0.25 to 0.5 inches, and is sized to ensure steady flow regardless of cold and ambient/windchill temperatures.

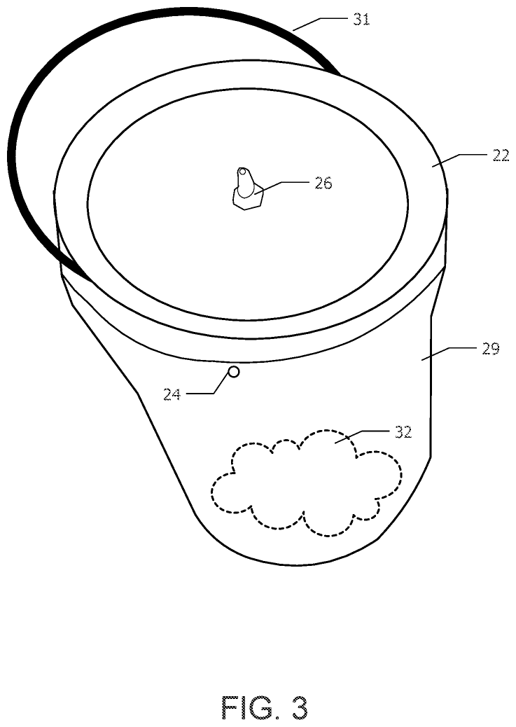

FIG. 3 illustrates an example embodiment of a collection bucket in a system for providing a portable urinal for use outdoors according to the present invention. The flexible hose 20 is downwardly routed for attachment to a resealable urine collection assembly 21. The resealable urine collection assembly may be free-standing on the ground or may be hung by an integrated handle 31 of the urine container 29. The urine collection assembly 21 is comprised of a lower resealable lid assembly 22, a urine container 29, and odor-controlling media 32 such as cat litter, and similar materials within the urine container.

The lower resealable lid assembly 22 is comprised of a lower resealable lid 23, a threaded barbed hose connector 26, a barbed hose connector nut 27, and optional adhesive (not shown). The lower end of the flexible hose 20 is pressed onto/over the barbed feature provided by the threaded barbed hose connector 26. This pressed connection may be carefully detached without damage to hose or barb as needed for maintenance, portability, and hose replacement.

This connection is leak-proof and doesn't require tools such as with mechanical clamps, hose rings, etc. The barbed feature and the flexible hose 20 are non-metallic, thereby ensuring quietness as urine passes from the flexible hose 20 into the threaded barbed hose connector 26. Urine flows into the urine collection assembly 21 from the flexible hose 20 into a threaded barbed hose connector 26 and is deposited into the odor-controlling media 32 located at bottom of the urine container 29. The urine collection assembly 21 includes the lower resealable lid assembly 22, which in turn includes lower resealable lid 23, the lower resealable lid assembly 22, a threaded barbed hose connector 26, a barbed hose connector nut 27, and optional adhesive. By integrating non-metallic components, concerns of corrosion by exposure to urine are eliminated.

The lower resealable lid assembly 22 is used to seal off the urine container 29 via a detachable sealed connection (sealed bucket lid, screw top, other) to the open end of the urine container 30. The lower resealable lid 23 has an integrated vent hole 24 and an integrated influx hole 25. The integrated vent hole is provided to allow for pressure relief during urine influx. The threaded barbed hose connector 26 is inserted into the integrated influx hole 25 on the lower resealable lid 23. The barbed hose connector nut 27 secures the threaded barbed hose connector 26 to the integrated influx hole 25 of the lower resealable lid 23. The adhesive is optional and may be applied to the threaded portion of the threaded barbed hose connector 26 immediately prior to screwing on the barbed hose connector nut 27 to ensure fixation to the lower resealable lid 23, thereby completing the lower resealable lid assembly 22.

The urine container 29 consists of an open end 30 and an integrated handle 31. The open end 30 of the urine container corresponds to a mouth of the unit. The lower resealable lid 23 either screws-on or snaps-on (i.e., resealable bucket lid style) onto this opening to provide a sealed closed container of urine and associated odors. The integrated handle of the urine container is a carrying handle. The odor controlling media is a scent-free, clumping odor controlling media 32 such as silica desiccant or other absorbent material that is placed in the bottom of the urine container 29.

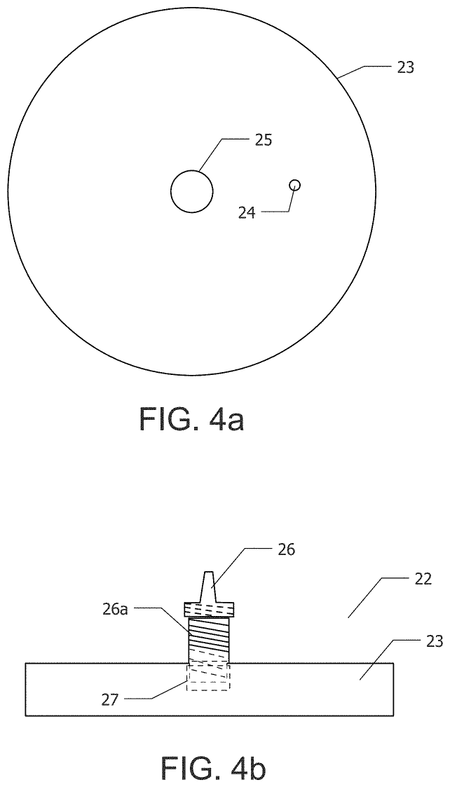

FIG. 4a-b illustrate a lid for a collection bucket for use in a system for providing a portable urinal for use according to the present invention. Attachment of the threaded barbed hose connector 26 begins with insertion to the integrated influx hole 25 with the threaded shank 26a protruding from the underside of the lower resealable lid 23. Adhesive (not shown) is optionally applied to the threads immediately prior to screwing on the barbed hose connector nut 27.

This use of adhesive ensures permanent fixation of the threaded barbed hose connector 26 to the lower resealable lid 23 thereby improving system robustness and guarding against looseness, noise, and odor emission as urine falls to the odor-controlling media 32 below. Ultimately, urine passes through the flexible hose 20 into the threaded hose barbed connector 26 into the urine container 29 which has been sealed off with the resealable lower lid assembly 22.

The small integrated vent hole 24 is provided in the lower resealable lid 23 or in the urine container 29 for internal pressure relief of the sealed urine collection assembly 21 during the influx of urine, to prevent pressure build-up due to hot weather, etc. The hole is sized to keep the odor emission to a minimum. In a preferred embodiment, the small integrated vent hole 24 is located on the side of the urine container 29 as a location in the lower resealable lid 23 may permit melting snow and rain water to enter the urine container 29 if the device is left outdoors for an extended period of time.

Upon entering the urine collection assembly 21 the urine mixes with the odor-controlling media 32 located at the interior bottom section of the urine container 29. The odor-controlling media 32 is intended to be similar to environmentally friendly, clumping cat litter media. In addition to urine odor neutralization, due to its soft granulated properties, noise is kept to a minimum upon impact of the urine stream into the odor controlling-media 32.

Even though combinations of features are recited in the present application, these particular combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

1. A system for providing a portable urinal, the system comprises:
a urinal unit assembly comprising;
a urinal body having an inflow opening for accepting urine from a user and an exit port coupled to a flexible hose;
a lanyard assembly having a long arm segment and a short arm segment, the long arm segment couples the urinal body to an elevated location, the lanyard assembly and the short arm segment couples the urinal body to a second elevated location; and
an upper resealable lid for coupling to the urinal body, the upper resealable lid completely cover the inflow opening of the urinal body; and
a flexible hose connecting the exit port of the urinal body to the threaded barbed hose connector on a lower resealable lid assembly within a urine collection assembly;
the urine collection assembly comprising:
a lower resealable lid assembly having the threaded barbed hose connector and a barbed hose connector nut coupled to the threaded barbed hose connector holding the threaded barbed hose connector to the lower resealable lid assembly; and
a urine container coupled to the lower resealable lid assembly; and
odor controlling media within the urine container.

2. The system according to claim 1, wherein the elevated location is a tree branch.

3. The system according to claim 1, wherein the second elevated location is a part of a tree stand.

4. The system according to claim 1, wherein the upper resealable lid is coupled to the urine assembly unit via a tether.

5. The system according to claim 1, wherein the odor controlling media comprises kitty litter.

6. The system according to claim 1, wherein the exit port comprises a barbed hose connector coupled to the urinal body, the flexible hose of coupled to the barbed hose connector.
